(19) United States
(12) Patent Application Publication
(10) Pub. No.: US 2004/0078948 A1
(43) Pub. Date: Apr. 29, 2004

(54) Bracket for lay-on cables

(76) Inventor: Yoke Keong Yong, Puchong (MY)

Correspondence Address: MEDLEN & CARROLL, LLP, 101 Howard Street, Suite 350, San Francisco, CA, 94105, US

(21) Appl. No.: 10/428,025

(22) Filed: Apr. 30, 2003

Related U.S. Application Data
(63) Continuation of application No. 09/728,166, filed on Dec. 1, 2000, now abandoned.
Application No. 09/728,166 is a continuation of application No. 09/072,760, filed on May 5, 1998, now abandoned.

(30) Foreign Application Priority Data
Nov. 3, 1997 (MY) PI 9705195

(51) Int. Cl. B23P 11/00

(52) U.S. Cl. 29/428

(57) ABSTRACT

The present invention provides a bracket for the ease of installing cables in or on a partition wall, wherein the bracket is comprised of a base member for mounting onto the frame of the partition wall, and for providing a means to support cables laid onto said bracket. The back portion of the base member is provided with partition wall mounting means (e.g, hooks), for mounting the bracket onto a partition wall frame. The front portion of the base member is provided for laying onto and supporting the cables that have been laid onto the bracket. A hinge portion is provided at one end of the base member to provide for pivotal movement with the base member. Preferred embodiments provide for either a separate member or integrally fabricated member which is pivotally connected to the base member at the hinge portion. Such separate or integral member may be adapted to engage a partition panel cover or as a bracket cover member.

### FIELD OF THE INVENTION

This invention relates to the laying-on of utility wires and cables behind the panels of the partition wall system.

### BACKGROUND OF THE INVENTION

Modular partition walls are increasingly being used in the office environment because of their flexibility in reorganization and reconfiguration within an open office space. As each room or cubicle formed by the partition wall requires utility lines such as electrical power cables, telephone wires and computer networking data lines (hereinafter collectively referred to as “cables”), these cables have to be laid within the partition walls both for safety and aesthetic reasons.

In most offices, both the conventional wire and cable laying arrangement and partition wall systems typically comprise of a partition wall frame, removable panels and/or panel covers. In the conventional method of laying the cables, the length of each cable required is determined by laying the cables alongside the partition walls from the utility common source to the outlet in the partition. The cables are then cut to the desired length and the ends thereof are inserted to “snake” laboriously through the openings in the partition wall frame for the entire length of the cables used. Panels are then installed to cover the cables that now run within the wall frames in order to protect them from the office environment, as well for aesthetic reasons.

When the office layout is changed and the partition wall dismantled for reconfiguration, the cables have to be pulled out from the partition wall frame beforehand and after the reconfiguration, the cables must laid by inserting them through the holes of the partition wall frame. During this manipulation, the cables are necessarily pulled through the openings, around corners of the partition, etc., resulting in potential damage to the cables, such as the danger of scratching the insulating sheath of layers of the cables and exposing the wires within. Thus, the end-to-end laying of cables may be hazardous in the event an electrical power cable is damaged by the pulling method or loss of signal in the case of telephone and computer data lines. In addition, there is the risk of damage to the partition walls themselves during this process.

### DESCRIPTION OF THE FIGURES

FIG. 1 provides an illustrative comparison of the conventional laying of cables via the partition wall frame with the present invention, in which the cables are transversely placed onto the brackets at the panel plane.

FIG. 2 shows the basic configuration of an embodiment of the bracket of the present invention. Panel 2A shows the front portion while Panel 2B shows the back portion.

FIG. 3 shows an embodiment of the bracket of the present invention in which one cable support means for each cable is provided.

FIG. 4 shows an embodiment of the bracket of the present invention in which a hinge portion is provided as a weakened spot, and a bracket cover member is also provided.

FIG. 5 shows an embodiment of the hinge portion of the bracket.

FIG. 6 shows another embodiment of the hinge portion of the bracket.

### SUMMARY OF THE INVENTION

This invention relates to the laying-on of utility wires and cables behind the panels of the partition wall system.

The present invention provides methods laying cables within a partition wall, comprising: a) providing a partition wall comprising a partition frame and one or more partition panels; a bracket comprising a base member having a back portion and a front portion, the back portion comprising a mounting means, and the front portion comprising one or more cable support means, wherein the cable support means is configured to permit the tranverse laying of cable; and one or more cables; b) mounting the bracket to one of the partition panels with the mounting means; and c) transversely laying the cable in the bracket under conditions such that the cable is supported by the cable support means. In some preferred methods, the mounting means is comprised of one or more projections arising from the back portion. In other preferred methods, the cable support means are formed integrally with the base member to form one or more ribs extending from the front portion of the base member, and the ribs extend to form a substantially encasing support means. In yet other embodiments, the one or more ribs further comprises a weakened spot. In some preferred embodiments, the weakened spot comprises a snap-hinge, wherein the snap-hinge comprises a snap portion and a hinge portion. In further preferred embodiments, the hinge portion of the snap-hinge provides pliability to the front section of the bracket in relationship to the base member. In still other preferred embodiments, each of the cable support means further comprises at least one opening. In alternative embodiments, the ribs are fabricated into a vertical series of cable support means. In yet further embodiments, the wall frame has one or more holes, and each of the projections is fabricated to hook the holes in the partition wall frame. In some preferred embodiments, the mounting means comprises at least one outline hook frame made of resilient polymeric material, and at least one solid hook fabricated integrally with the base member.

The present invention also provides methods for laying cables within a partition wall, comprising: a) providing a partition wall comprising a partition frame and one or more partition panels; a bracket comprising a base member comprising a back portion and a front portion, and a hinge portion, wherein the back portion comprises a mounting means and the front portion comprises one or more cable support means, wherein the cable support means is configured to permit the tranverse laying of cable; and one or more cables; b) mounting the bracket to one of the partition panels with the mounting means; and c) transversely laying the cable in the bracket under conditions such that the cable is supported by the cable support means. In some embodiments, the hinge portion further comprises a pivotal portion and a stationary portion, and wherein a joint is positioned between the pivotal and stationary portions. In certain preferred embodiments, the pivotal portion is integral with the base member, while in other preferred embodiments, the stationary portion is integral with the base member. In still other preferred embodiments, the pivotal portion of the hinge portion integral with the base member is positioned between a pair of hinge pin end holders, wherein the hinge pin end holders are a portion of a panel cover flange.

In alternative embodiments, the stationary portion of the hinge portion integral with the base member is positioned between a pair of hinge pin end holders, wherein the hinge pin end holders are a portion of a panel cover flange. In yet other embodiments, the pivotal portion and the stationary portion of the hinge portion are joined by a hinge pin transfixed through the pivotal part and the stationary part. In still further embodiments, the hinge portion is comprised of a pawl-and-ratchet means and a ratchet release means. In other embodiments, the pivotal portion and the stationary portion of the hinge portion provide a slideably movable pivotal guide pin and a semi-circular pivotal groove. In some preferred embodiments, the pivotal groove comprises an opening having resilient ends.

In other preferred embodiments, the hinge portion is positioned at the proximal end of the base member, and the hinge portion provides pivotal connection between the base member and a removable partition panel cover, and the base member has a panel cover engagement means positioned at the distal end of the base member for engaging the partition panel cover. In still other preferred embodiments, the length of the base member spans the width of the partition panel cover, such that the panel cover engagement means positioned at the distal end of the base member snugly engages a portion of the partition panel cover, and wherein the portion of the panel cover is a flange. In further embodiments, the distal end of the panel engagement means is snugly engaged with the panel cover flange by a tongue-and-groove means.

In additional embodiments, the bracket further comprises a panel cover attachment member for attaching to a partition panel cover, and wherein the hinge portion provides the pivot between the base member and the panel cover attachment member. In still other embodiments, the panel cover attachment member further comprises an arm portion having two ends. In yet additional embodiments, the arm portion transcends the breadth of the inner width of the partition panel cover. In further embodiments, at least one of two ends of the arm portion is provided with a flange extension. In some preferred embodiments, the method further comprises providing a bracket cover member, and wherein the hinge portion provides for pivotal movement of the bracket cover member which extends to cover the height of the partition panel cover.

The present invention also provides bracket comprising a base member comprising a hinge portion, a back portion and a front portion, the back portion comprising a mounting means, the front portion comprising one or more cable support means, the cable support means configured to permit the tranverse laying of cable, and wherein the hinge portion provides pivotal connection between the base member and a removable partition panel cover. In some embodiments of the bracket, the base member has a panel cover engagement means positioned at the distal end of the base member for engaging the partition panel cover. In still other embodiments, the hinge portion further comprises a pivotal portion and a stationary portion, and wherein a joint is positioned between the pivotal and stationary portions. In some preferred embodiments, the pivotal portion of the hinge portion integral with the base member is positioned between a pair of hinge pin end holders, wherein the hinge pin end holders are a portion of a panel cover flange. In some preferred embodiments, the pivotal portion is integral with the base member, while the stationary portion is integral with the base member.

In still other embodiments, the stationary portion of the hinge portion integral with the base member is positioned between a pair of hinge pin end holders, wherein the hinge pin end holders are a portion of a panel cover flange. In yet other embodiments, the pivotal portion and the stationary portion of the hinge portion are joined by a hinge pin transfixed through the pivotal part and the stationary part. In some preferred embodiments, the hinge portion is comprised of a pawl-and-ratchet means and a ratchet release means. In yet other preferred embodiments, the pivotal portion and the stationary portion of the hinge portion provide a slideably movable pivotal guide pin and a semi-circular pivotal groove. In some preferred embodiments, the pivotal groove comprises an opening having resilient ends. In yet other preferred embodiments, the hinge portion is positioned at the proximal end of the base member, and the hinge portion provides pivotal connection between the base member and a removable partition panel cover, and the base member has a panel cover engagement means positioned at the distal end of the base member for engaging the partition panel cover. In yet other embodiments, the length of the base member spans the width of the partition panel cover, such that the panel cover engagement means positioned at the distal end of the base member snugly engages a portion of the partition panel cover, and wherein the portion of the panel cover is a flange. In still other embodiments, the distal end of the panel engagement means is snugly engaged with the panel cover flange by a tongue-and-groove means.

In yet other embodiments, the bracket further comprises a panel cover attachment member for attaching to a partition panel cover, and wherein the hinge portion provides the pivot between the base member and the panel cover attachment member. In some preferred embodiments, the panel cover attachment member further comprises an arm portion having two ends. In other preferred embodiments, the arm portion transcends the breadth of the inner width of the partition panel cover. In still further embodiments, at least one of two ends of the arm portion is provided with a flange extension. In still other embodiments, the bracket of the present invention further comprises a bracket cover member, and wherein the hinge portion provides for pivotal movement of the bracket cover member which extends to cover the height of the partition panel cover.

The present invention also provides a partition wall system comprising at least one wall frame, at least one detachable panel, at least one panel covers, and at least one bracket. In some embodiments, the bracket comprises a base member having a back portion and a front portion, the back portion having partition wall mounting means for mounting the bracket onto the frame of the partition wall, and the front portion having with one or more cable support means for supporting the cables laid onto the bracket and at least one end of the base member being a hinge portion for providing a pivotal support thereon. In still other embodiments the partition wall system further comprises a partition wall mounting means, wherein the partition wall mounting means is comprised of one or more projections arising from the back portion of the back member. In other embodiments, the partition wall mounting means comprises at least one or more outline hook frames of resilient polymeric material. In still other embodiments, the partition wall mounting means comprises at least one or more solid hooks, wherein the solid hooks are integrally fabricated with the base member. In still other embodiments, the cable support means are formed integrally with the base member in the form of at least one rib extending from the front portion of the base member, and wherein the rib extends to form a substantially encasing support means for holding at least one cable running laterally through the bracket. In further embodiments, the rib further comprises a weakened spot. In yet other preferred embodiments, the partition wall further comprises a plurality of cable support means. In other preferred embodiments, the one or more ribs are fabricated the cable support means positioned in a vertical series. In still other embodiments, the cable support means each holds one cable.

### GENERAL DESCRIPTION OF THE INVENTION

The present invention provides a bracket for supporting lay-on cables within a partition wall. The bracket of the present invention includes a base member having a back portion and a front portion, the back portion being provided with partition wall mounting means for mounting the bracket onto a frame of the partition wall, the front portion being provided with one or more cable support means for supporting cables laid onto the bracket, at least one end of the base member being provided with a hinge portion for providing a pivotal support thereon.

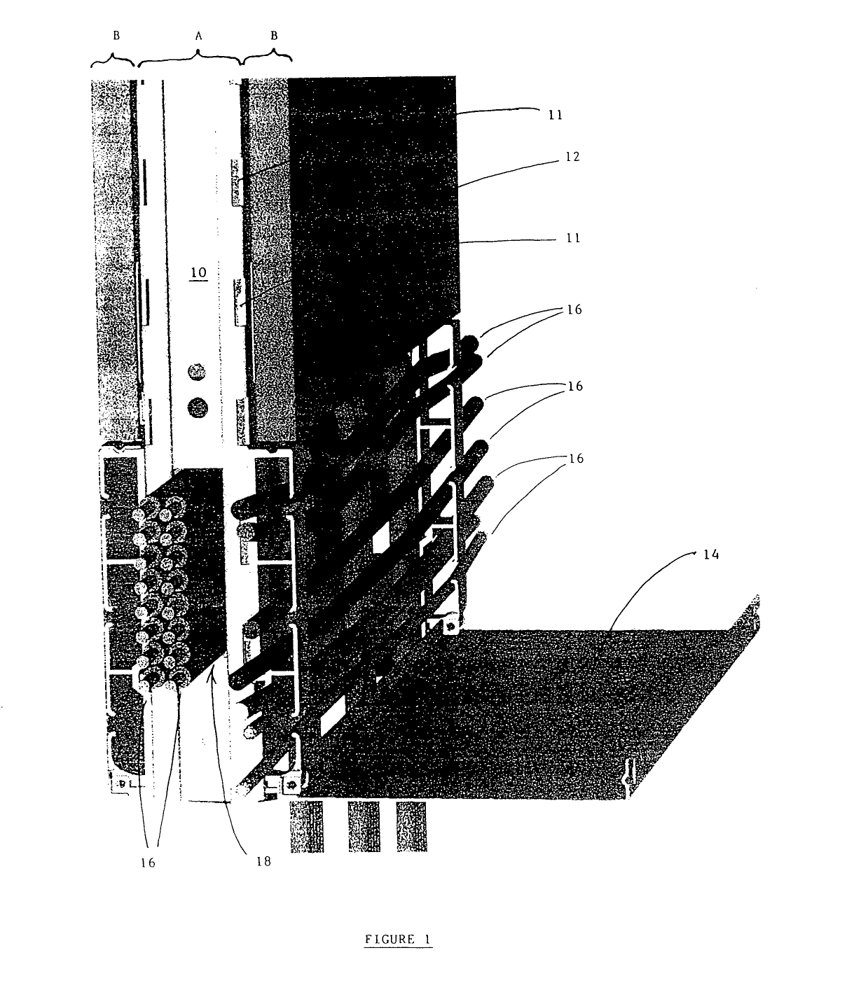

The present invention, therefore, alleviates the problems referred to previously by providing for brackets for laying of the cables, as the invention does not rely on the end-to-end laying of the cables within the partition wall frame (10). The brackets of the present invention allow for the transverse laying on the cables at the partition panel plane (B) rather than the partition frame (A). For example, as shown in FIG. 1, the cables (16) may be transversely and directly laid onto the brackets without the need for pulling the cables through. Thus, the task of laying the cables is easier and is less damaging to the cables and partition. FIG. 1 shows the conventional arrangement in comparison with the present invention.

In some preferred embodiments, the partition wall mounting means provided on the back portion of the base member may comprise of one or more projections arising from the back portion, with the projection being fabricated to hook onto a corresponding hole on the partition wall frame. The hook means may comprise of at least one or combination of (i) an outline hook frame and is made of resilient polymeric material and (ii) a solid hook, which are fabricated integrally with the base member.

In particularly preferred embodiments, the cable support means are formed integrally with the base member in the form of at least a rib extending from the base member's front portion. The rib may extend to form a substantially encasing support means for holding at least one cable running laterally through the bracket. The rib may further be provided with a weakened spot to increase the pliability of a frontal rib section of the cable support means to enable the rib section to be plied opened to ease the laying of cables into the cable support means. The weakened spot may be fabricated as a snap-hinge in which the frontal rib section may either snap-close or stay open due to the snap action of the snap hinge.

In an alternative preferred embodiment, each of the cable support means formed by the rib(s) is provided with at least an opening for laying-on of cables into the cable support means. The opening may be formed by the end of the ribs extending to enclose and define an enclosure but the opposing rib ends stop short of meeting one another to allow a gap thereinbetween as the opening to enable a cable to be laid into the enclosure by pushing the cable therethrough. The opposing rib ends may be tapered so as to be pliant and extend inwardly so that the gap is marginally narrower than the cable's diameter, thereby enabling a transversing cable to be pushed through the gap to distend the opposing pliant rib ends into the enclosure.

In another preferred embodiment, the bracket's plurality of cable support means is provided to group different transversing cables laid onto the bracket for utility and organizational purposes. Preferably still, the ribs are fabricated into a vertical series of cable support means each for one transversing cable.

In yet another embodiment, the hinge portion of the bracket may comprise of a weakened spot to enable the pliability of the bracket's frontal section from the base member. The weakened spot may be fabricated as a snap-hinge.

Preferably, the hinge portion may comprised of a joint between any one of (i) a pivotal part and (ii) a stationary part, one of the two parts being integral with the base member and the other part to another member.

In yet another embodiment, the pivotal part and the stationary part of the hinge portion may be joined by a hinge pin transfixing through the pivotal part and stationary part, and wherein the other part is the corresponding edge of the panel cover's flange. The hinge body of the hinge portion may be integral with the base member and may be fitted in between a pair of hinge pin end holders formed by the folding of the edge of the panel cover's flange, the hinge is formed when the hinge pin transfixes the pair of pin holders with the hinge body in between. The pivotal part of the hinge portion may be integral with the base member and may be provided as a pair of pin end holders in between the hinge body of the hinge portion which may be formed by the folding of the edge of the panel cover's flange, the hinge thus formed when the hinge pin transfixes the pair of pin holders with the stationary part in between. In another embodiment, the hinge portion may be comprised of a pawl-and-ratchet means so that the pivotal part may be pivotally lifted to stay in an opened position, and a ratchet release means so that the pivotal part may be pivotally folded back to a closed position.

In one embodiment, the pivotal part and the stationary part of the hinge portion are alternatively provided as a pivotal guide pin and a semi-circular pivotal groove wherein the guide pin may slideably move, and the pivot groove defines the pivotal movement allowable for the panel cover and wherein the one of either guide pin or groove is provided on the pivotal part and the other on the stationary part of the hinge portion. Preferably, the pivotal groove is provided with an opening which has ends that are resilient and terminates in a ridge that narrows the opening so that when the guide pin slides out of the groove into the opening and rests on the ridge, some force is required to push the guide pin to overcome the ridge to slide into the groove again.

In other preferred embodiments, the hinge portion at the proximal end of the base member provides for a pivotal connection between the base member and a removable partition panel cover. In this embodiment, the base member is provided with a panel cover engagement means at the distal end for engaging the partition panel cover.

In one embodiment of the bracket, the base member's length spans the width of the partition panel cover so that the panel cover engagement means at the distal end of the base member may snugly engage the corresponding inner surface of the panel cover's flange. In a preferred embodiment, the panel engagement means' distal end surface and the inner surface of panel cover's flange are engageable by tongue-and-groove means.

In yet another embodiment, the bracket is provided with another member as a panel cover attachment member for attaching to a removable partition panel cover, and wherein the hinge portion provides the pivot between the base member and the panel cover attachment member. The panel cover attachment member may comprise an arm portion which transcends the breath of the inner width of the removal partition panel cover so that the attachment member fits in securely between the flanged edges of the panel cover's inner side. Preferably, at least one of the two ends of the arm portion is provided with a flange extension to engage the inner surface of the corresponding panel cover's flange edge; the flange extension's engagement surface and the corresponding engagement surface of the flange edge is provided with a tongue-in-groove means.

In another embodiment of the bracket, the hinge portion at one end of the base member provides for a pivotal movement of a bracket cover member which extends to cover the height of the partition panel cover. Preferably, the bracket cover member is fabricated integrally with the base member and the hinge portion is fabricated as a weakened spot.

In yet further embodiments, the bracket cover member is pivotably hinged at the proximal end of the base member at the hinge portion, pivotably moved to cover over the cable support means and securely engageable to a complementary part of a securing means at the distal end of the base member via any one of the following securing means—complementary hook means, tongue-and-groove means, or magnetic means.

In yet other embodiments, a bracket employing one or more of the foregoing features may be used in the space in between two adjacent partition panel covers. Generally, a partition wall system comprising wall frame, detachable panels and panel covers may be adapted to accommodate and install one or more embodiments of the bracket.

### DETAILED DESCRIPTION OF THE INVENTION

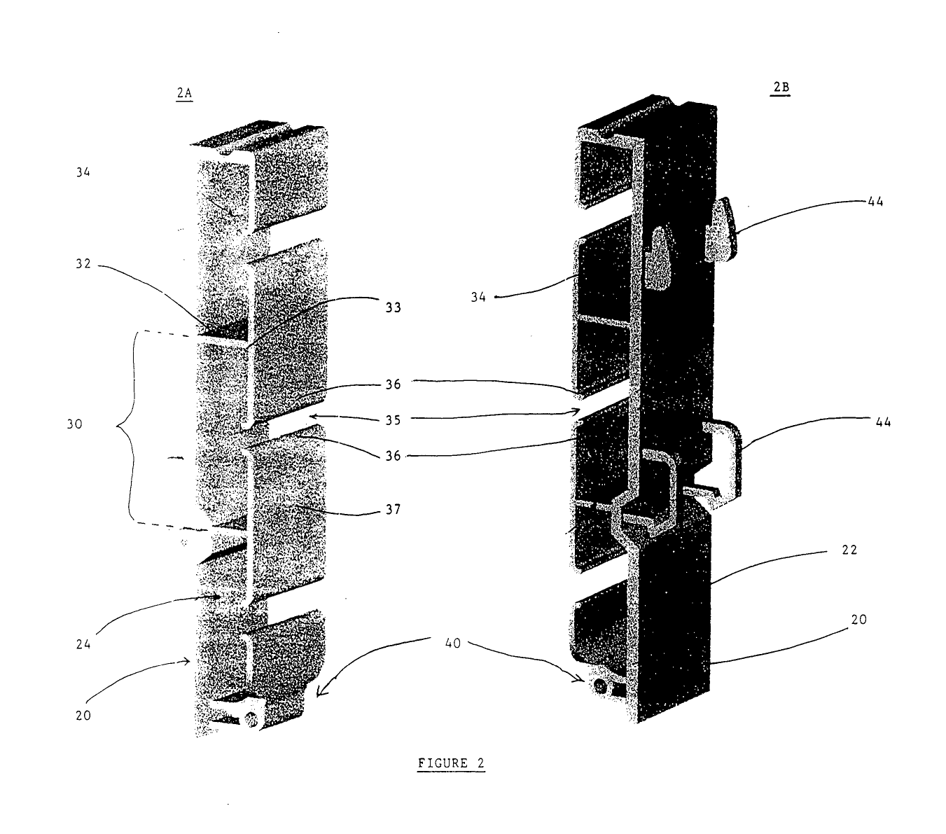

The bracket of the present invention eases the laying of cables within a partition wall, specifically the laying of cables at the partition panel plane (B) as comparatively shown in FIG. 1. As shown in FIG. 2, the basic configuration of the bracket comprises a base member (20) which principally serves as a base for providing means for mounting the bracket onto the partition wall's frame and for providing a means to support cables that have been laid onto the bracket.

A typical partition wall frame (10) comprises of a frame of horizontal and vertical members joined to one another to form a modular partition wall frame. For horizontal connection modularity, the vertical members at the edge of each frame are normally provided with holes (11), as shown in FIG. 1, which are provided equidistant along the edge. These holes (11) may be used for connection via the partition wall system's accessory parts to join with another wall frame, or used for mounting partition panels.

The base member (20) of the bracket of the invention, as shown in FIG. 2B, is characterized in that its back portion (22) is provided with partition wall mounting means for mounting the bracket onto a partition wall frame using the holes (11) in the same manner as the conventional accessory parts of the partition wall frame. The front portion (24) of base member is provided with one or more cable support means (30) for laying onto and supporting cables (16) (not shown) that have been laid onto the bracket. Further, a hinge portion (40) is provided at least one end of the base member to provide for pivotal movement with the base member (20). The hinge portion serves as a pivotal point for a pivotal movement of either (i) an integral part of the bracket, (ii) a separate member of the bracket, or (iii) a separate member such as the removable panel or panel cover.

In one embodiment of the invention, the bracket is provided with partition wall mounting means provided on the back portion (22) of the base member (20). The mounting means may be comprised of one or more projections arising from the back portion (22) wherein each of the projections is fabricated in such a manner so as to hook onto a corresponding hole (11) on the partition wall frame (10). It will be apparent that the position of each of these projections matches the position of the holes (11) on the wall frame (10) so that the bracket may be mounted thereonto.

In one preferred embodiment of the present invention, the projection making up the hook means comprises of at least one or more in combination of (i) a resilient outline hook frame (42) and (ii) an solid hook (44), which are fabricated of resilient polymeric material integrally with the base member (20). The outline hook frame (42), due to its thin frame outline made of resilient polymeric material, is resiliently deformable and may be forced into a corresponding hole (11) on the partition wall frame (10). The solid hook (44), due to its solid configuration, is stronger and less deformable.

As shown in FIG. 2A and 2B, both these two examples of the hook means (40) may be complementarily used to mount the bracket onto the partition wall frame's holes (11). The upper hook (44) (i.e., the solid one), may be first inserted into the corresponding upper hole (not shown) on the wall frame (10) and, thereafter, the lower hook (42) (i.e., the deformable resilient outline frame of a hook), may be inserted to snap into the corresponding lower hole (not shown), thus securely mounting the bracket onto the wall frame (10). To dismount, the same lower, deformable and resilient hook may be pulled out of the hole first before the upper solid hook (44) may be disengaged from the hole. Those of skill in the art will recognize that other types of hook means or combinations of these hook means would be equally effective in mounting the bracket onto a partition wall frame. Thus, it is not intended that the invention be limited to any specific means for mounting the bracket onto a partition wall frame.

In a preferred embodiment of the invention, the bracket's cable support means (30) are formed integrally with the base member (20) in the form of at least one rib (32) extending from the base member's front portion (24), said rib (32) extending to form a substantially encasing support means for holding at least one cable (16) running laterally and transversely through the bracket.

These are various configuration of the rib to enable the cable support means to provide the necessary means to support and/or substantially encase the cable running transversely through the bracket. As shown in FIG. 2A and FIG. 2B, the ribs (32) may extend to form T-branches (33) which in complement with the adjoining ribs (32) may form a suitable enclosure (34) in an encasing manner for the cable (16). It is preferred that each of the cable support means (30) so formed by the ribs (32, 33) is provided with at least an opening (35) for the ease of laying-on of cables (16) into the cable support means (30) or enclosures.

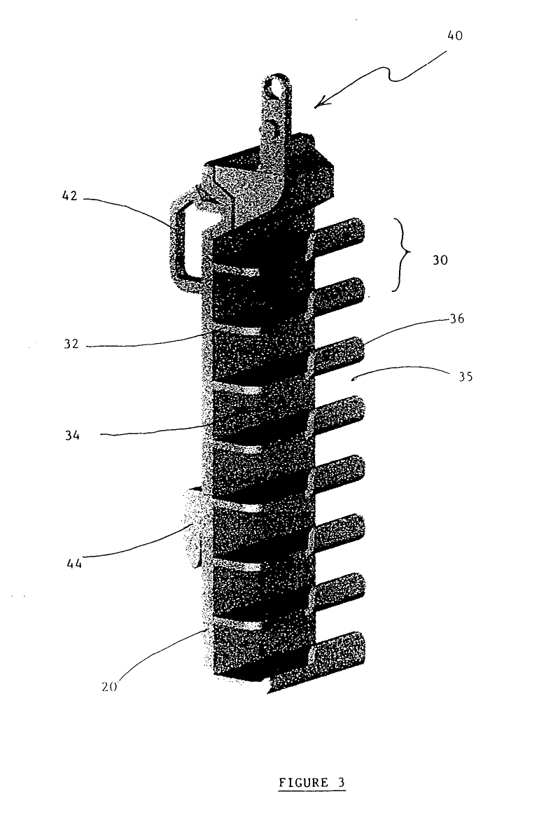

The opening (35) may be formed by the rib ends (36) extending to enclose and define the enclosure (34) and wherein the opposing rib ends (36) stop short of meeting one another to allow a gap therein between as the opening (35) to enable a cable to be laid into the enclosure by pushing the cable (16) therethrough. Preferably, the opposing rib ends (36) are tapered and thinned so that their flexibility and pliability increase with their ends tapered inwardly so that the gap is marginally narrower than the extended cable's diameter. In this manner, a transversing cable (16) may be pushed through the gap or opening (35) to distend the opposing pliant rib ends (36) into the enclosure (34) In one preferred embodiment of the bracket, a plurality of the cable support means (30) may be provided to organize or group different types of transversing cables or wires laid onto the bracket for utility organizational purposes. For example, electrical power cables, computer networking cables and telephone wire lines may each be laid onto a support means (30) of the same respective positions in all the brackets installed in a partition wall system so as to minimize crossing of cables of different utility as they are laid within the partition wall system. In another preferred embodiment of the bracket, the ribs (32) may be fabricated into a vertical series of cable support means (30) so that each support means (33) may cater for one transversing cable as shown in FIG. 3.

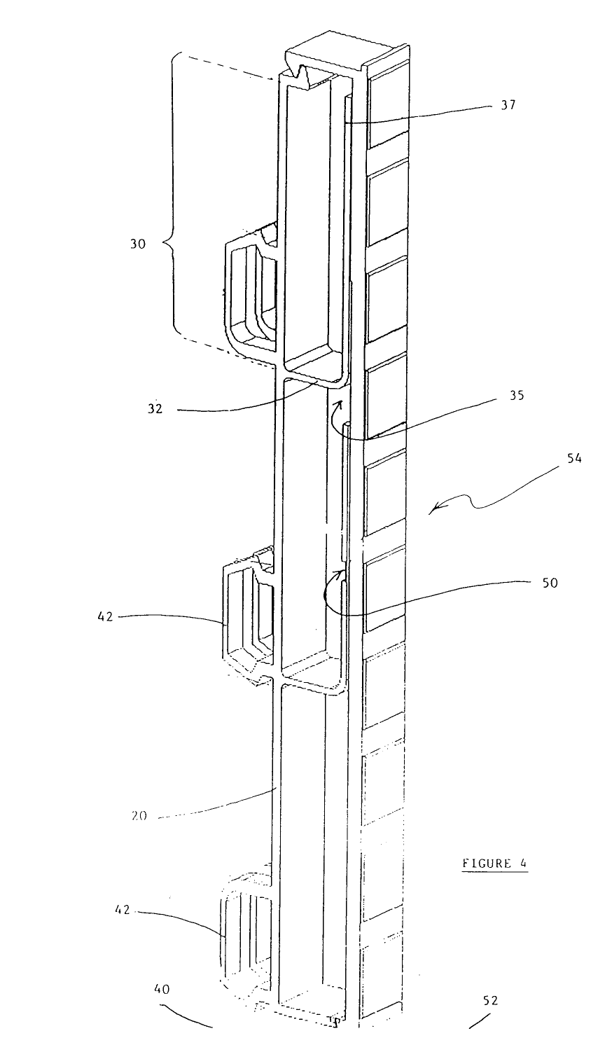

In a preferred embodiment of the invention, as shown in FIG. 4, the cable support means as defined by the ribs (32) is provided with at least one weakened spot (50) to increase the pliability of a frontal rib section (37) of the cable support means (30) to enable said rib section to be plied open to ease the laying of cables into said cable support means.

Preferably still, the weakened spot (50) is fabricated as a snap-hinge wherein the frontal rib section (37) is respectively snap-closed or stays opened due to the snap action of the snap hinge. Such snap-action hinge design for a planar hinge may be easily adapted from any of the conventional snap hinges as disclosed in European patent EP-0,056,469, German patent DE-1,808,875, Swiss patent CH-488,085, French patent FR-1,595,023 and U.S. patents U.S. Pat. No. 3,135,458 and U.S. Pat. No. 3,616,487 (all of which are herein incorporated by reference). Some of these patents, for example, EP-0,056,469, are for use in hinging a cylindrical bottle cap body with the cap lid or cover but may be easily adapted by a person skilled in the art for hinging between two planar members as in the present bracket.

In a manner similar to the frontal rib section (37), the hinge portion (40) of the bracket may be provided as a weakened spot (52) as shown in FIG. 4. Such a weakened spot (52) may enable the bracket's frontal section to be pliable to ease the pivotal distention of the other member (such as a bracket cover member (54) as shown in FIG. 4) from the base member (20). As in the case of the frontal rib section (37), the weakened spot may be fabricated as a snap-hinge as modified from the prior art described above.

The provision of a hinge portion is essentially to provide for a pivotal movement between two parts or members. In the present invention, the hinge portion (40) of the bracket provides for similar pivotal movement between two parts or members of the brackets joined to one another at the hinge portion (40) (i.e. between any one of (i) a pivotal part and (ii) a stationary part). One of the parts may be integral with the base member (20) and the other part being or connected to another member. This other member may be a bracket cover member (54), a corresponding edge of the partition panels cover's (14) flange or like member or part.

Due to the bracket's function as a bracket for cables and wires, in preferred embodiments, the base member (20) forms the stationary part while the other member is provided to join to the base member (20) at the hinge portion (40) as the pivotal part or member. Preferably, the hinge portion (40) may comprise of a joint between any one of (i) a pivotal part and (ii) a stationary part, one of the two parts being integral with the base member and the other part to another member.

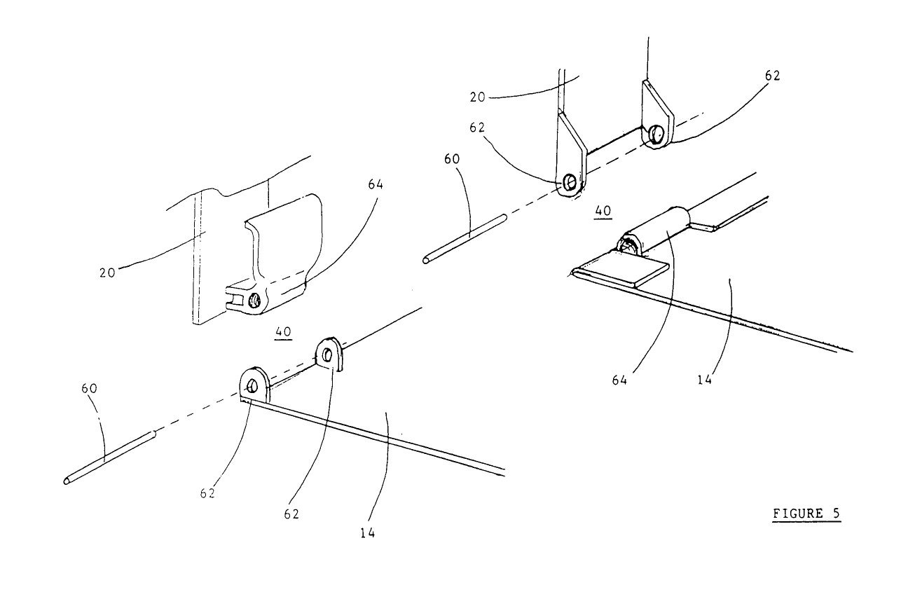

As a specific embodiment shown in FIG. 5, the hinge portion (40) may provide for the hinge joining between the bracket unit and a partition panel cover (14) whereby the pivotal part and the stationary part of the hinge portion (40) may be joined by a hinge pin (60) transfixing through said pivotal part and stationary part. The stationary part may be advantageously provided on the base member since the bracket should remain stationary in carrying the cables and wires within a partition wall panel. Accordingly, the pivotal part may be provided as or connected to the panel cover (14), preferably to a corresponding edge of the panel cover's (14) flange.

In particularly preferred embodiments, the hinge body (64) of the hinge portion (40) may be integral with the base member (20) and is fitted in between a pair of hinge pin end holders (62) formed by the folding of the edge of the panels cover's (14) flange, the hinge is formed when the hinge pin (60) transfixes said pair of pin holders (62) with said hinge body in between. In other embodiments, the reverse is also possible (i e., the base member is provided with a pair of pin end holders (62) in between the hinge body part of the hinge portion (40) which is formed by the folding of the edge of the panels cover's (14) flange so that the hinge is formed when the hinge pin (60) transfixes said pair of pin holders (62) with said hinge body (64) in between).

Apart from such hinge pin embodiment, it is apparent that other conventional means of hinging are possible such as a pawl-and-ratchet means so that the panel may be pivotally lifted to stay in an opened position, and a ratchet release means may be provided so that the pivotal part may be pivotally folded back to a closed position. Thus, it is not intended that the present invention be limited to any specific means of hanging.

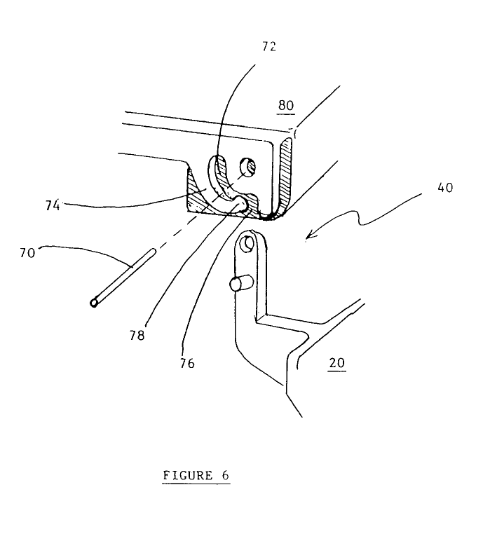

In another alternative embodiment of the bracket's hinge portion (40), as shown in FIG. 6, the pivotal part and the stationary part may be provided as a pivotal guide pin (70) and a semi-circular pivotal groove (12) wherein between said guide pin may slideably move. As shown in FIG. 6, the pivotal guide (70) is provided integral with the stationary part of the hinge which is provided on the bracket unit while the pivotal groove is provided on the pivotal part of the hinge. As in case of FIG. 5, the reverse is also contemplated (i.e. the pivotal pin is provided on the pivotal part of the hinge and the pivotal groove is provided on the stationary part of the hinge which is integral with the bracket).

The pivotal groove defines the pivotal movement freedom allowable for the panel cover and, preferably, the pivotal groove is formed by a semi-enclosing rib (74) which terminates with an opening (76) at one end of rib (78). The rib end (78) is preferably resilient and terminates in a ridge that narrows the opening so that when the panel cover is lifted to open, the guide pin slides and snaps out of the groove into the opening and may rest on the ridge. Thus, the stationary part of the hinge is connected to a panel cover or connected to a member which engages the panel cover, the panel cover may remain in the opened or lifted position and so that some force is required to push the pin to overcome the ridge to slide into the groove again to allow the panel cover to be folded back to the closed position.

In one preferred embodiment, the hinge portion (40) at the proximal end of the base member (20) provides for a pivotal connection between the base member (20) and a removable partition panel cover (14). The base member (20) may be provided with a panel cover engagement means (80) at the distal end for engaging the partition panel cover (14).

In one specific embodiment, the base member's (20) length spans the width of the partition panel cover (14) so that the panel cover engagement means at the distal end of the base member (20) may snugly engage the corresponding inner surface of the panel cover's (14) flange. Many means of engaging the panel cover's flange are possible, for example, the panel engagement means distal end surface and the inner surface of panel cover's flange are engageable by tongue-and-groove means (i.e., the tongue part may be provided on either the flange of the panel cover and the groove on the distal end of the base member or vice versa).

In another specific embodiment, the bracket may be provided with another member in the form of a panel cover attachment member (80) for attaching to a removable partition panel cover. In this embodiment, the hinge portion provides the pivot between the base member and the panel cover attachment member. Preferably, the panel cover attachment member (80) comprises an arm portion which transcends the breath of the inner width of the removable partition panel cover (14) so that the attachment member fits in securely between the flanged edges of the panel cover's inner side. In particularly preferred embodiments, at least one of two ends of the arm portion is provided with an flange extension to engage the inner surface of the corresponding panel cover's flange edge. The flange extension's engagement surface and the corresponding engagement surface of the flange edge may be provided with a tongue-in-groove means.

In yet another embodiment of the bracket, the hinge portion at one end of the base member may provide for pivotal movement between the base member and a bracket cover member (54) as in FIG. 4. Preferably, when the bracket member is used in the space between two panels, the bracket cover member extends to cover the height of the partition panel cover and may be further provided with patterns, designs or fabric on the outside surface so as to provide the inter-panel space with aesthetical continuity with pattern, design or fabric of the panel cover.

Preferably still, the bracket cover member is pivotably hinged at proximal end of the base member at the hinge portion and may be pivotably moved to cover over the cable support means. For the cover member to securely cover the cable support means, means may be provided to engage the distal end of the cover member to a complementary part of the distal end of the base member. The engagement means may be adapted from any one of the following securing means—complementary hook means (as shown in FIG. 4), tongue-and-groove means, or magnetic means.

It is intended that the bracket unit of this invention be molded from a suitable polymeric material which offers suitable resilience and pliability according to different parts or members of the bracket. From the above description on the general features and working principles of the invention and the specific embodiments thereof, those of skill in the art will recognize that there are many variations and alternative embodiments that may be used in substitution of the steps or processes of the present invention's method, and many of the various parts, components or alternative embodiments not specifically described herein may be used in substitution of the corresponding elements of the method and apparatus of the present invention.

For instance, there are many variation of the methods that may be used to attach the bracket to the partition wall frame and such methods may be equally applicable in the present invention. It would be apparent to a person skilled in the art that the use of the bracket need not be restricted to a partition wall system and may be adapted for used in other wall or furniture systems wherein a frame and cover panels are involved. The bracket described herein, too, has many possibilities of alternate parts or materials that may be used as substitutes to effectively employ the features and working principles thereof. These embodiments are not to be considered as departures from the present invention as illustrated by the examples and specific embodiments described herein and shall be considered as falling within the letter and spirit of the following claims.

1. A method for laying cables within a partition wall, comprising:
a) providing:
i) a partition wall comprising a partition frame and one or more partition panels;
ii) a bracket comprising a base member having a back portion and a front portion, said back portion comprising a mounting means, and said front portion comprising one or more cable support means, wherein said cable support means is configured to permit the tranverse laying of cable; and
iii) one or more cables;
b) mounting said bracket to one of said partition panels with said mounting means; and
c) transversely laying said cable in said bracket under conditions such that said cable is supported by said cable support means.

2. The method of claim 1, wherein said mounting means is comprised of one or more projections arising from said back portion.

3. The method of claim 2, wherein said cable support means are formed integrally with said base member to form one or more ribs extending from said front portion of said base member, and said ribs extend to form a substantially encasing support means.

4. The method of claim 3, wherein said one or more ribs further comprises a weakened spot.

5. The method of claim 4, wherein said weakened spot comprises a snap-hinge, wherein said snap-hinge comprises a snap portion and a hinge portion.

6. The method of claim 5, wherein said hinge portion of said snap-hinge provides pliability to said front section of said bracket in relationship to said base member.

7. The method of claim 3, wherein each of said cable support means further comprises at least one opening.

8. The method of claim 3, wherein said ribs are fabricated into a vertical series of cable support means.

9. The method of claim 3, wherein said wall frame has one or more holes, and each of said projections is fabricated to hook said holes in said partition wall frame.

10. The method of claim 9, wherein said mounting means comprises at least one outline hook frame made of resilient polymeric material, and at least one solid hook fabricated integrally with said base member.

11. A method for laying cables within a partition wall, comprising:
a) providing:
i) a partition wall comprising a partition frame and one or more partition panels;
ii) a bracket comprising a base member comprising a back portion and a front portion, and a hinge portion, wherein said back portion comprises a mounting means and said front portion comprises one or more cable support means, wherein said cable support means is configured to permit the tranverse laying of cable; and
iii) one or more cables;
b) mounting said bracket to one of said partition panels with said mounting means; and
c) transversely laying said cable in said bracket under conditions such that said cable is supported by said cable support means.

12. The method of claim 11, wherein said hinge portion further comprises a pivotal portion and a stationary portion, and wherein a joint is positioned between said pivotal and stationary portions.

13. The method of claim 12, wherein said pivotal portion is integral with said base member.

14. The method of claim 12, wherein said stationary portion is integral with said base member.

15. The method of claim 13, wherein said pivotal portion of said hinge portion integral with said base member is positioned between a pair of hinge pin end holders, wherein said hinge pin end holders are a portion of a panel cover flange.

16. The method of claim 14, wherein said stationary portion of said hinge portion integral with said base member is positioned between a pair of hinge pin end holders, wherein said hinge pin end holders are a portion of a panel cover flange.

17. The method of claim 12, wherein said pivotal portion and said stationary portion of said hinge portion are joined by a hinge pin transfixed through said pivotal part and said stationary part.

18. The method of claim 11, wherein said hinge portion is comprised of a pawl-and-ratchet means and a ratchet release means.

19. The method of claim 11, wherein said pivotal portion and said stationary portion of said hinge portion provide a slideably movable pivotal guide pin and a semi-circular pivotal groove.

20. The method of claim 19, wherein said pivotal groove comprises an opening having resilient ends.

21. The method of claim 12, wherein said hinge portion is positioned at the proximal end of said base member, and said hinge portion provides pivotal connection between said base member and a removable partition panel cover, and said base member has a panel cover engagement means positioned at the distal end of said base member for engaging said partition panel cover.

22. The method of claim 21, wherein the length of said base member spans the width of said partition panel cover, such that said panel cover engagement means positioned at said distal end of said base member snugly engages a portion of said partition panel cover, and wherein said portion of said panel cover is a flange.

23. The method of claim 22, wherein said distal end of said panel engagement means is snugly engaged with said panel cover flange by a tongue-and-groove means.

24. The method of claim 22, wherein said bracket further comprises a panel cover attachment member for attaching to a partition panel cover, and wherein said hinge portion provides the pivot between said base member and said panel cover attachment member.

25. The method of claim 24, wherein said panel cover attachment member further comprises an arm portion having two ends.

26. The method of claim 25, wherein said arm portion transcends the breadth of the inner width of said partition panel cover.

27. The method of claim 25, wherein at least one of two ends of said arm portion is provided with a flange extension.

28. The method of claim 21, further comprising a bracket cover member, and wherein said hinge portion provides for pivotal movement of said bracket cover member which extends to cover the height of said partition panel cover.

29. A bracket comprising a base member comprising a hinge portion, a back portion and a front portion, said back portion comprising a mounting means, said front portion comprising one or more cable support means, said cable support means configured to permit the tranverse laying of cable, and wherein said hinge portion provides pivotal connection between said base member and a removable partition panel cover.

30. The bracket of claim 29, wherein said base member has a panel cover engagement means positioned at the distal end of said base member for engaging said partition panel cover.

31. The bracket of claim 29, wherein said hinge portion further comprises a pivotal portion and a stationary portion, and wherein a joint is positioned between said pivotal and stationary portions.

32. The bracket of claim 31, wherein said pivotal portion of said hinge portion integral with said base member is positioned between a pair of hinge pin end holders, wherein said hinge pin end holders are a portion of a panel cover flange.

33. The bracket of claim 29, wherein said pivotal portion is integral with said base member.

34. The bracket of claim 29, wherein said stationary portion is integral with said base member.

35. The bracket of claim 34, wherein said stationary portion of said hinge portion integral with said base member is positioned between a pair of hinge pin end holders, wherein said hinge pin end holders are a portion of a panel cover flange.

36. The bracket of claim 29, wherein said pivotal portion and said stationary portion of said hinge portion are joined by a hinge pin transfixed through said pivotal part and said stationary part.

37. The bracket of claim 29, wherein said hinge portion is comprised of a pawl-and-ratchet means and a ratchet release means.

38. The bracket of claim 29, wherein said pivotal portion and said stationary portion of said hinge portion provide a slideably movable pivotal guide pin and a semi-circular pivotal groove.

39. The bracket of claim 38, wherein said pivotal groove comprises an opening having resilient ends.

40. The bracket of claim 29, wherein said hinge portion is positioned at the proximal end of said base member, and said hinge portion provides pivotal connection between said base member and a removable partition panel cover, and said base member has a panel cover engagement means positioned at the distal end of said base member for engaging said partition panel cover.

41. The bracket of claim 29, wherein the length of said base member spans the width of said partition panel cover, such that said panel cover engagement means positioned at said distal end of said base member snugly engages a portion of said partition panel cover, and wherein said portion of said panel cover is a flange.

42. The bracket of claim 41, wherein said distal end of said panel engagement means is snugly engaged with said panel cover flange by a tongue-and-groove means.

43. The bracket of claim 42, wherein said bracket further comprises a panel cover attachment member for attaching to a partition panel cover, and wherein said hinge portion provides the pivot between said base member and said panel cover attachment member.

44. The bracket of claim 43, wherein said panel cover attachment member further comprises an arm portion having two ends.

45. The bracket of claim 44, wherein said arm portion transcends the breadth of the inner width of said partition panel cover.

46. The bracket of claim 44, wherein at least one of two ends of said arm portion is provided with a flange extension.

47. The bracket of claim 29, further comprising a bracket cover member, and wherein said hinge portion provides for pivotal movement of said bracket cover member which extends to cover the height of said partition panel cover.
